(19) United States
(12) Patent Application Publication
(10) Pub. No.: US 2002/0120653 A1
(43) Pub. Date: Aug. 29, 2002

(54) Resizing text contained in an image

(75) Inventors: Reiner Kraft, Gilroy, CA (US); Stephen A. Mortinger, Walnut Creek, CA (US)

Correspondence Address: Gregory A. Nelson, Akerman Senterfitt, 222 Lakeview Avenue, Fourth Floor, P.O. Box 3188, West Palm Beach, FL, 33402-3188, US

(73) Assignee: International Business Machines Corporation, Armonk, NY (US)

(21) Appl. No.: 09/794,781

(22) Filed: Feb. 27, 2001

(51) Int. Cl. G06F 17/24; G06F 17/00

(52) U.S. Cl. 707/529; 707/520

(57) ABSTRACT

A system for resizing text contained in an image can include a browser for displaying a hypermedia document; an extractor/separator for identifying images in the hypermedia document; a filter for identifying text portions of the identified images; an optical character recognition (OCR) system for processing the identified text portions, the OCR system producing recognized text; and, a user interface for displaying the recognized text concurrently with the display of the hypermedia document in the browser. The system can further include a text-to-speech (TTS) conversion system for converting the recognized text to audible speech; and, an audio user interface (AUI) for presenting the TTS audible speech concurrently with the display of the hypermedia document in the browser.

### BACKGROUND OF THE INVENTION

1. Technical Field

The present invention relates to the field of document browsers, and more particularly, to resizing text contained in images which are displayable in a hypermedia document browser.

2. Description of the Related Art

Hypermedia documents are those documents which can include both content and hyperlinks embedded among the content. While content typically can include text, content can also include multimedia data and program scripts. Moreover, the hyperlinks embedded among the content of a hypermedia document can refer to additional content either separately or in other hypermedia documents. Conventional hypermedia documents can be viewed in hypermedia document browsers which are configured to process both the content and the hyperlinks embedded among the content. Hypermedia documents typically can be encoded using a markup language, for instance hypertext markup language (HTML), extensible markup language (XML), wireless markup language (WML), etc. Notably, one collection of hypermedia documents distributed across a publicly accessible network such as the Internet and viewable through hypermedia document browsers has been aptly referred to as a “World Wide Web” (Web).

The Internet, and particularly the Web, has altered how people carry out the more mundane activities of life. For instance, newspapers are now being delivered via the Internet rather than by newspaper carriers so that subscribers can read the newspapers through their Web browsers rather than in print. Still, introducing new services for delivering hypermedia content is not without its drawbacks. For instance, people having poor vision are unable to read text contained in those images which can be displayed in a hypermedia document browser. For example, viewing the comics section of a newspaper through a Web browser can be problematic for those subscribers having poor vision or an inadequate display device.

While conventional hypermedia document browsers such as Web browsers permit viewers to adjust the size and typeface of fonts used to display textual hypermedia content, this method of adjusting font attributes is wholly ineffective when text is contained as part of an image. In particular, images, unlike textual content, typically are represented as bitmapped graphics using any of the well-known graphics formats such as JPEG or GIF. In consequence, images can be enlarged or reduced (“resized”) using conventional bitmap enlargement and reduction algorithms. As an example, some operating systems include accessibility accessories which provide magnifiers that can be used to enlarge the presentation of content through a display. Also, some mouse drivers can zoom a particular portion of a display centered about a displayable mouse pointer, typically in response to a user depressing a hotkey.

Nevertheless, while attempts have been made to increase the font size and typeface of text contained in an image by using accessibility or resizing facilities, such solutions have significant limitations. Specifically, when a resizing function has been activated, the entire displayed image is resized and the user can lose relative perspective or overview of the image. Additionally, the overall quality of images deteriorate as the resizing factor is increased. Accordingly, conventional hypermedia document browsers cannot adjust the size of text contained in an image without also changing the size of the image.

### SUMMARY OF THE INVENTION

The invention discloses a method and apparatus for resizing text contained in an image viewable in a browser. The method for resizing the text contained in an image viewable in a browser can include the steps of recognizing text contained in an image included in a hypermedia document displayed in a hypermedia document browser; and, providing a resizable display of the recognized text in a user interface concurrently with the display of the hypermedia document in the hypermedia document browser. The text recognition step can further include identifying an image in the hypermedia document; further identifying text contained in the identified image; and, processing the identified text in an optical character recognition (OCR) system, the processing producing recognized text.

Notably, the method of the invention can process text contained in multiple images in a hypermedia document. More particularly, the method of the invention can further include identifying additional images in the hypermedia document, the additional images containing corresponding additional text; further identifying the corresponding additional text contained in the additional images; processing the further identified additional text in the OCR system, the processing producing additional recognized text; and, providing a resizable display for selected ones of the additional recognized text concurrently with the display of the hypermedia document in the hypermedia document browser. Notably, each of these steps can be performed sequentially in regard to each identified image in the hypermedia document, or in batch-mode wherein all of the images are identified and stored in a list prior to processing by the OCR system.

In one aspect of the present invention, the identifying step can include parsing the hypermedia document for embedded image references. Moreover, in another aspect of the present invention, the providing step can include transcoding the hypermedia document to accommodate a resizable display, wherein the transcoding step embeds an image identifier in the hypermedia document. Subsequently, responsive to detecting user interaction with an image associated with the identifier, a resizable display of recognized text contained in the image can be provided. In yet another aspect of the invention, the transcoding step can include embedding a marker in the hypermedia document proximately to the image, wherein the marker can indicate the availability of a resizable display for resizably displaying text contained in the image. Importantly, the detected user interaction can include pointing device events which occur positionally proximate to the text contained in the image.

Notably, a display template can be created for the hypermedia document which can indicate whether an image contains text which can be resizably displayed in accordance with the inventive arrangements. In particular, the method of the invention can further include determining whether each identified image contains text which can be resizably displayed in a user interface; creating a display template corresponding to the hypermedia document; and, displaying the display template. Importantly, the display template can schematically illustrate portions of the hypermedia document which contain image portions which are determined to contain text which can be resizably displayed in a user interface.

In one aspect of the present invention, the method can also include text-to-speech (TTS) converting the recognized text; and, presenting the TTS converted text in an audio user interface (AUI) concurrently with the display of the hypermedia document in the hypermedia document browser. As such, the method also can include the steps of determining whether each identified image contains text which can be resizably displayed in a user interface and further determining whether each identified image contains text which can be audibly presented in an AUI; creating a display template corresponding to the hypermedia document, the display template schematically illustrating both portions of the hypermedia document which contain image portions which are determined to contain text which can be resizably displayed in a user interface, and portions of the hypermedia document which contain image portions which are determined to contain text which can be audibly presented in an AUI; and, displaying the display template.

A system for resizing text contained in an image in accordance with the inventive arrangement can include a browser for displaying a hypermedia document; an extractor/separator for identifying images in the hypermedia document; a filter for identifying text portions of the identified images; an optical character recognition (OCR) system for processing the identified text portions, the OCR system producing recognized text; and, a user interface for displaying the recognized text concurrently with the display of the hypermedia document in the browser. The system can further include a text-to-speech (TTS) conversion system for converting the recognized text to audible speech; and, an audio user interface (AUI) for presenting the TTS audible speech concurrently with the display of the hypermedia document in the browser. Moreover, the system can also include a transcoder for reformatting the hypermedia document to accommodate a resizable display, the transcoder embedding an image identifier associated with the image in the hypermedia document; and, an event handler for providing a resizable display of the recognized text responsive to detecting an operating system event relating to the image. Finally, the system can include a display template generator for creating a display template corresponding to the hypermedia document, the display template schematically illustrating both portions of the hypermedia document which contain images which are determined to contain text which can be resizably displayed in a user interface; and, a user interface for displaying the display template concurrently with the display of the hypermedia document in the browser.

### BRIEF DESCRIPTION OF THE DRAWINGS

There are presently shown in the drawings embodiments of which are presently preferred, it being understood, however, that the invention is not so limited to the precise arrangements and instrumentalities shown, wherein:

FIG. 1 is a block illustration of an exemplary system for processing text contained in an image in a hypermedia document;

FIG. 2 is a flow chart illustrating an exemplary method for processing text contained in an image in a hypermedia document;

FIG. 3 is a pictorial illustration of a method for processing text contained in an image in a hypermedia document including resizable text and audio markers.

FIG. 4 is a pictorial illustration of a method for processing text contained in an image in a hypermedia document in which a hypermedia document template can be generated.

FIG. 5 is a pictorial illustration of a method for processing text contained in an image in a hypermedia document in which recognized text can be displayed in a pop-up window.

### DETAILED DESCRIPTION OF THE INVENTION

The invention provides both a method and system for resizing text contained in images which are displayable in a browser. The method can include identifying images in a hypermedia document, extracting text from the identified images, and presenting the text in a user interface concurrently with the display of the hypermedia document in the browser. In particular, the text can be extracted from the image using conventional optical character recognition (OCR). Importantly, the hypermedia document can be coded to support the presentation of extracted text responsive to user interface events relating to the presentation of the hypermedia document. For instance, the hypermedia document can be coded in accordance with a markup language such that when a mouse pointer passes over a visually displayed image contained in the hypermedia document, the extracted text can be presented visually in a pop-up window or audibly using a TTS-based audio user interface.

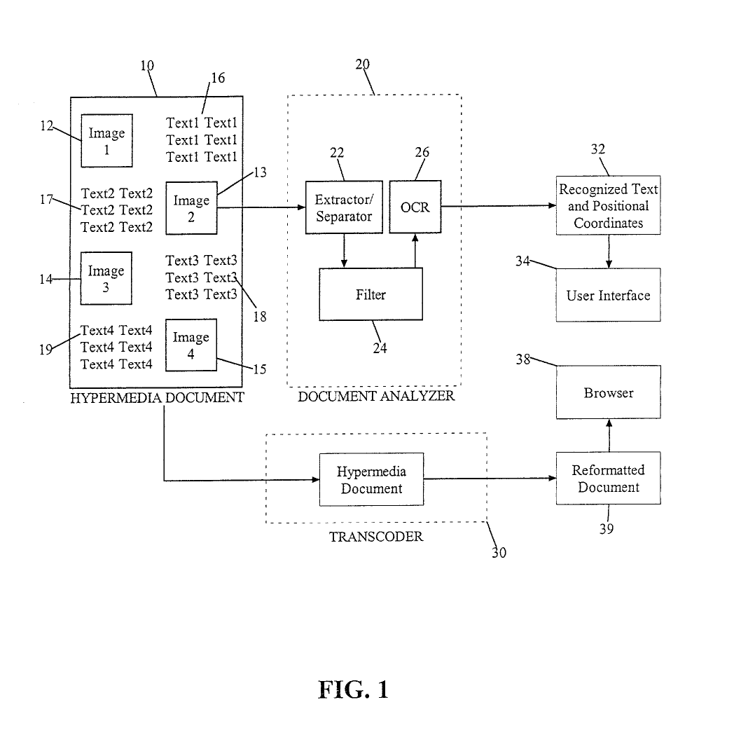

FIG. 1 is a block illustration of an exemplary system for processing text contained in images in a hypermedia document. As shown in FIG. 1, the exemplary system can include a hypermedia document 10 which can be displayed in a document browser. The hypermedia document can include both images 12, 13, 14, 15 and text 16, 17, 18, 19. Still, the invention is not limited to the particular combination of text and images shown in FIG. 1. Rather, the hypermedia document 10 can include not only text and images, but also multimedia elements and, generally, any object which can be referenced by or embedded within a conventional hypermedia document.

The document analyzer 20 can process the various elements contained in the hypermedia document 10 in order to produce extracted text representative of text contained in the images 12, 13, 14, 15. In particular, the document analyzer 20 can include an extractor/separator 22 for identifying the images 12, 13, 14, 15 contained in the hypermedia document 10. Once the extractor/separator 22 has identified images 12, 13, 14, 15, a filter 24 can locate and separate text portions of the images 12, 13, 14, 15 from the non-text portions (graphics) of the images 12, 13, 14, 15. Finally, the text portions of the images 12, 13, 14, 15 can be converted to recognized text 32 using an OCR system 26. Notably, the OCR system 26 can be any suitable, conventional OCR system which can produce recognized text processable by any conventional text processing tool.

The hypermedia document 10 can be processed by a transcoder 30, which can format the hypermedia document 10 to include new functionality for resizably presenting the recognized text 32 in a user interface 34. By resizably presenting the recognized text 32 in a user interface 34, it is meant that the recognized text 32 can be resized in the separate user interface 34 so that, while the font size and typeface of the recognized text 32 can be changed, the entire hypermedia document need not change as well. Notably, the user interface 34 can be a browser. As will be apparent to one skilled in the art, browsers can process and present the content of a document which is coded in accordance with a markup language. Exemplary markup languages can include, but are not limited to HTML, XML, and WML.

In one particular aspect of the present invention, the transcoder 30 can reformat the hypermedia document 10 into a reformatted document 39 which can rendered by a browser 38. The reformatted document 39 can include references to scripts or event handlers for processing user interface events associated with the images 12, 13, 14, 15 contained in the hypermedia document 10. In the case, for example, where a mouse-over event occurs relative to one of the images 12, 13, 14, 15, a pop-up window containing the recognized text 32, or an audio playback of the extracted text 32 can be provided. Alternatively, a pop-up menu can be provided from which various resizing functions can be selected.

Importantly, the system of the invention can be implemented as a plug-in to a hypermedia document browser in which requested hypermedia documents can be processed in accordance with the inventive arrangements as such requested hypermedia documents are retrieved from network storage. Alternatively, the system of the invention can be implemented as a proxy server to hypermedia document browsers. In this implementation, hypermedia documents requested by communicatively linked browsers can be processed in accordance with the inventive arrangements. Finally, the system of the invention can be implemented as a stand-alone application which can process images and the text contained therein, providing a concurrent display both of the image and of the text.

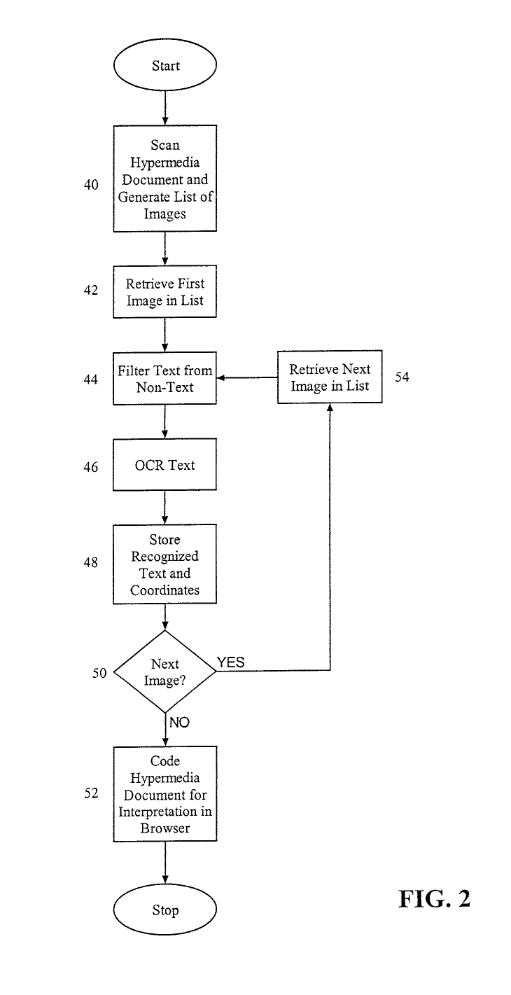

FIG. 2 is a flow chart illustrating an exemplary method for processing text contained in an image in a hypermedia document. Referring to FIG. 2, in block 40 initially a hypermedia document can be scanned and a list of images contained therein generated. In particular, the hypermedia document can be parsed for image references. For instance, in an HTML-based Web page, references to an image contained in the Web page can be coded using the markup tag, “<IMG>”. Hence, images contained in a Web page can be identified by the markup tag, “<IMG>”. Accordingly, a list of images contained in the hypermedia document can be generated. Additionally, the positional coordinates of each corresponding image relative to the hypermedia document can be extracted from the image reference and stored for further processing. More particularly, the positional coordinates can be used to generate an image map for indicating the relative position of images and text portions of the hypermedia document. Subsequently, each image in the list can be further processed to extract text contained therein.

Specifically, in block 42, the first image in the list can be retrieved for further processing. In block 44, the text portions of the image can be located and separated from the non-text portions (graphics) of the images. In addition, like the scanning step of block 40, in the locating step of block 44, the positional coordinates of the text relative to the image can be stored in an image map for subsequent processing. Notably, the locating and separating step can be performed using any conventional image processing method as is well-known in the art of optical character recognition.

Subsequently, the text portions of the image can be processed in an OCR system wherein bitmapped text portions of the image can be converted to computer recognizable text referred to herein as extracted text. In block 48, the extracted text can be stored as can the positional coordinates of each text region contained in the image. In one aspect of the present invention, the extracted text and the corresponding positional coordinates can be stored in a suitably configured data structure. In decision block 50, if more images are present in the list of images, in block 54 the next image in the list can be retrieved and the process can repeat until no images remain in the list.

In block 52, once the extracted text has been created by the OCR system and stored in a suitable data structure for each image in the list, the hypermedia document can be transcoded for integration with the resizable presentation of the extracted text. Specifically, in one aspect of the invention, the hypermedia document can be reformatted to include specific references to identified images and scripts for resizably presenting text extracted therefrom in a user interface. For example, in the case of an HTML-formatted document, the image tag referencing a particular image can be transcoded as follows:

Image tag before:<IMG SRC=“my_cartoon.jpg” alt=“jake the dancing bird”>

Image tag after:<IMG ID=“image1” SRC=“my_cartoon.jpg” alt=“jake the dancing bird”>

Once the hypermedia document has been transcoded, the image tag can include an image identifier which can allow the image to be uniquely identified within the hypermedia document. Significantly, in one aspect of the present invention, if an image includes multiple graphics and text regions, the image identifier can be inadequate for identification the location of the text contained in the image. Notwithstanding, to overcome this problem, the image identifier can be replaced with an image map which can define an area for each of the identified graphics (or text) regions.

By transcoding the hypermedia document, upon presentation of the hypermedia document in a suitably configured document browser, particular user interface events can be trapped and handled which relate to the images contained in the hypermedia document. More particularly, in one aspect of the present invention, text contained in an image in the hypermedia document can be resizably presented in a pop-up window concurrently with the presentation of the hypermedia document in the browser, for example, when a mouse pointer passes within the proximity of the text or the image.

Notwithstanding, the present invention is not limited to the particular process for presenting text extracted from an image in the hypermedia document. Rather, any presentation method by which text contained in an image can be presented to a user through a user interface is contemplated by the invention disclosed herein. For instance, such presentation methods can include a separate browser window, a pop-up window, or merely a pop-up menu which provides user-control over resizing the extracted text. Furthermore, in a second aspect of the present invention, the extracted text can be audibly presented through an AUI concurrently with the presentation of the hypermedia document through the browser.

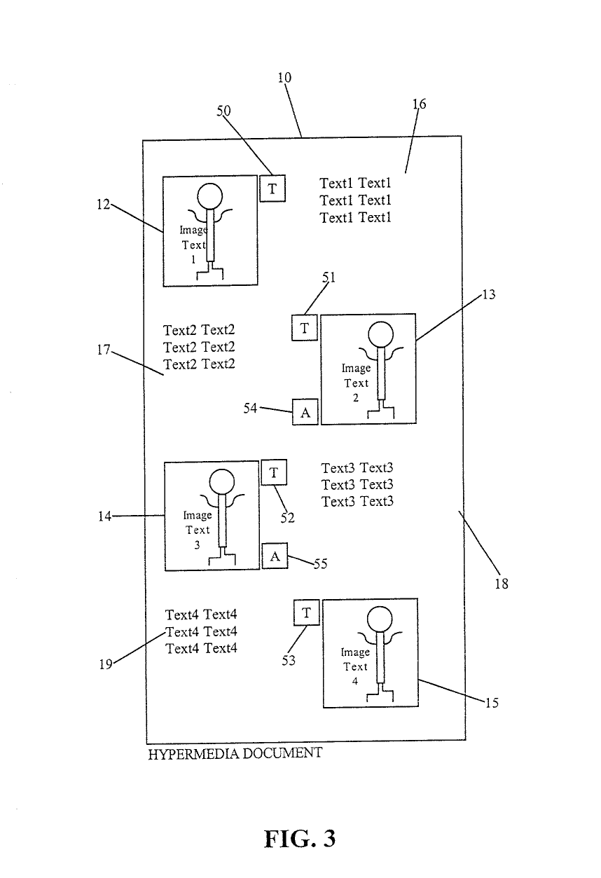

FIGS. 3 is a pictorial illustration of a method for presenting text contained in an image in a hypermedia document in a pop-up window wherein the hypermedia document has been transcoded to include resizable text markers and audio markers. Specifically, in an embodiment of the present invention, during the transcoding processing, markers can be inserted in the hypermedia document to indicate to a user which regions of the hypermedia document can be resizably displayed. In this way, it can be apparent to a user when text contained in an image can be resizably presented in a separate user interface.

Referring to FIG. 3, exemplary text markers 50, 51, 52, 53 are shown positioned proximately to images 12, 13, 14, 15 respectively in a hypermedia document 10. Though not apparent from the illustration, the markers 50, 51, 52, 53 can include, for example, hypertext text, highlighted text, or icons embedded in the hypermedia document 10. Notably, additional audio markers 54, 55 can be included to indicate to a user that an audio representation of the text contained in the image also is available. Notably, the audio representation can be a previously stored audio representation, or a dynamically presented audio presentation facilitated by TTS technology. Selecting, for example, an audio marker 54 and 55 can cause the playback of the text contained in the corresponding image 13, 14. Significantly, the audio playback of text contained in an image can be particularly important for users having disabilities.

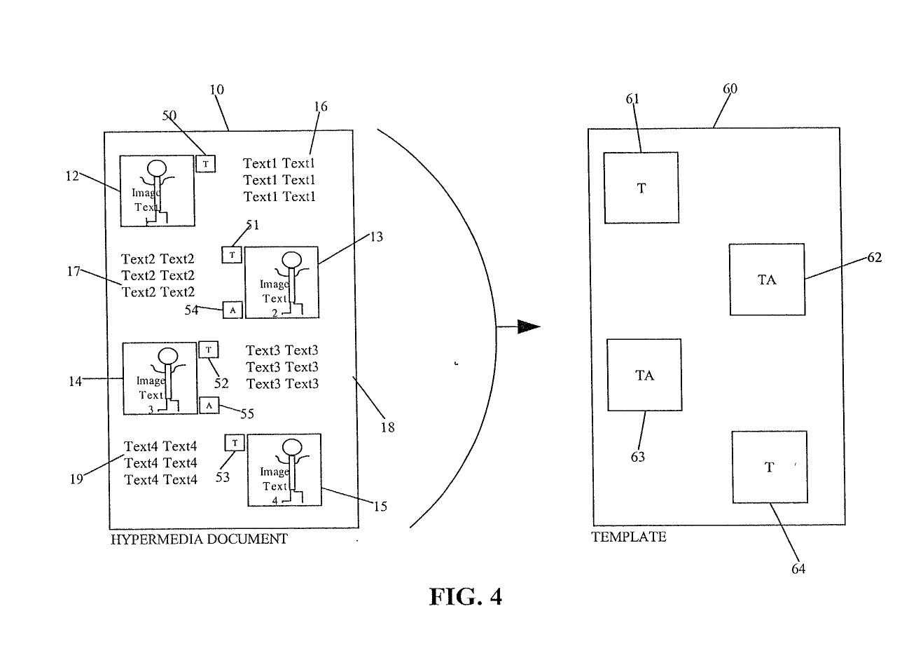

In yet a further embodiment of the invention, shown in FIG. 4, once the hypermedia document has been transcoded, a display template can be created from an image map of the hypermedia document 10 and presented to the user to facilitate the user's interaction with the system of the invention. An exemplary display template 60 generated from a hypermedia document 10 is illustrated in FIG. 4. The display template 60 can contain markers 61, 62, 63, 64 to indicate to a user the position of resizable text relative to the hypermedia document 10. The markers 61, 62, 63, 64 also can be configured to indicate to the user whether the text not only can be resizably presented, for instance in a pop-up window, but also whether the text can be audibly presented to the user through an audio user interface. Specifically, exemplary markers 62, 63 indicate an additional audio playback capability.

Notably, the template 60 can be integrated in a display as part of the hypermedia document 10, or the template 60 can be displayed in a separate pop-up window. In operation, a user can navigate the template 60 by selecting or passing a pointer over the markers 61. 62. 63. 64 in the template 60. Importantly, the invention is not limited in regard to the precise manner in which a user selects the markers 61, 62, 63, 64 in the template 60. In fact, while the pointer can be a mouse pointer or other similar pointing device, in other embodiments, in the case of a touch screen display, the pointer can be analogous to a finger touch on the screen. Furthermore, for handheld devices having touchscreen displays, the pointer can be a stylus.

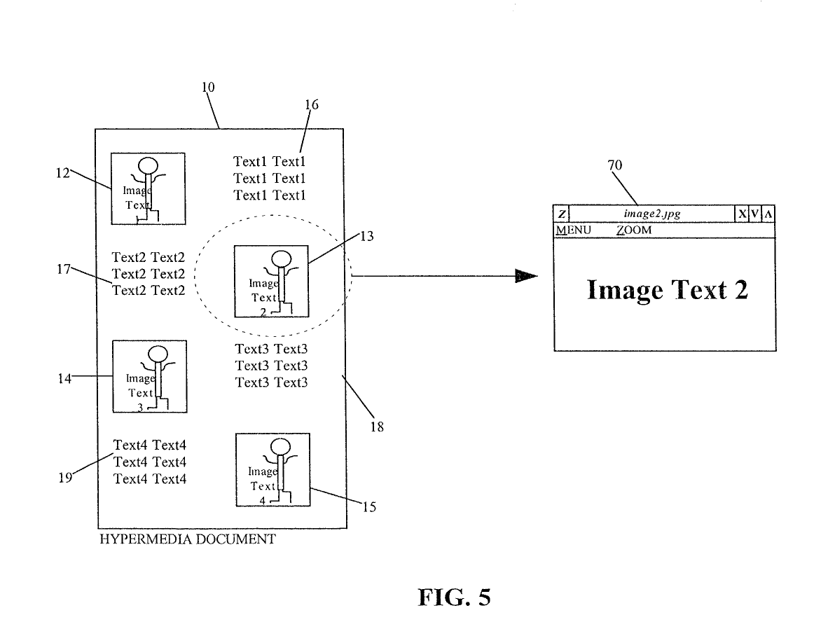

An exemplary pop-up window 70 for resizably presenting text contained in image 13 in a hypermedia document 10 is illustrated in FIG. 5. As shown in the illustration, a graphical pop-up window 70 can be displayed in such a manner that it overlays the hypermedia document 10, yet all the while maintaining the perspective or location relative to the position of the image 13 and text in the original hypermedia document 10. The size of the pop-up window 70 can be dynamically changed and the pop-up window 70 can be configured to scroll text displayed therein both horizontally and vertically in a coordinated manner with the movement of a pointer over the text contained in the image 13. This coordination can be particularly useful where the pop-up window 70 is not sized large enough to accommodate the entire portion of text contained in the image 13.

In a further aspect of the invention, a graphical user interface can be used to facilitate control of the size and appearance of the displayed text. As a result, users can control the size and attributes of the text according to, for example, display limitations and/or personal preferences. Alternately, a default user profile containing predefined display attributes can be used to display the text in the pop-up window. In this case, the default user profile can be modified at any time by the user. Finally, the pop-up window can have menus, buttons or other control mechanism for adjusting the viewing attributed, including modification of the default profile.

Notably, the present invention can be realized in hardware, software, or a combination of hardware and software. The method of the present invention can be realized in a centralized fashion in one computer system, or in a distributed fashion where different elements are spread across several interconnected computer systems. Any kind of computer system or other apparatus adapted for carrying out the methods described herein is suitable. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which when loaded in a computer system is able to carry out these methods. Computer program means or computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the foregoing specification illustrates and describes the preferred embodiments of this invention, it is to be understood that the invention is not limited to the precise construction herein disclosed. The invention can be embodied in other specific forms without departing from the spirit or essential attributes. Accordingly, reference should be made to the following claims, rather than to the foregoing specification, as indicating the scope of the invention.

We claim:

1. A method for resizing text contained in an image comprising:
recognizing text contained in an image included in a hypermedia document displayed in a hypermedia document browser; and,
providing a resizable display of said recognized text in a user interface concurrently with said display of said hypermedia document in said hypermedia document browser.

2. The method of claim 1, wherein the text recognition step comprises:
identifying an image in said hypermedia document;
further identifying text contained in said identified image; and,
processing said identified text in an optical character recognition (OCR) system, said processing producing recognized text.

3. The method of claim 2, further comprising:
identifying additional images in said hypermedia document, said additional images containing corresponding additional text;
further identifying said corresponding additional text contained in said additional images;
processing said further identified additional text in said OCR system, said processing producing additional recognized text; and,
providing a resizable display for selected ones of said additional recognized text concurrently with said display of said hypermedia document in said hypermedia document browser.

4. The method of claim 1, further comprising:
text-to-speech (TTS) converting said recognized text; and,
presenting said TTS converted text in an audio user interface (AUI) concurrently with said display of said hypermedia document in said hypermedia document browser.

5. The method of claim 2, wherein said identifying step comprises:
parsing said hypermedia document for embedded image references.

6. The method of claim 1, wherein said providing step comprises:
transcoding said hypermedia document to accommodate a resizable display, said transcoding embedding an image identifier in said hypermedia document; and,
responsive to detecting user interaction with an image associated with said identifier, providing a resizable display of recognized text contained in said image.

7. The method of claim 6, wherein said transcoding step comprises:
embedding a marker in said hypermedia document proximately to said image, said marker indicating the availability of a resizable display for resizably displaying text contained in said image.

8. The method of claim 5, wherein said detected user interaction comprises pointing device events occurring positionally proximate to said text contained in said image.

9. The method of claim 3, further comprising:
determining whether each identified image contains text which can be resizably displayed in a user interface;
creating a display template corresponding to said hypermedia document, said display template schematically illustrating portions of said hypermedia document which contain image portions which are determined to contain text which can be resizably displayed in a user interface; and,
displaying said display template.

10. The method of claim 4, further comprising:
determining whether each identified image contains text which can be resizably displayed in a user interface and further determining whether each identified image contains text which can be audibly presented in an AUI;
creating a display template corresponding to said hypermedia document, said display template schematically illustrating both portions of said hypermedia document which contain image portions which are determined to contain text which can be resizably displayed in a user interface, and portions of said hypermedia document which contain image portions which are determined to contain text which can be audibly presented in an AUI; and,
displaying said display template.

11. A system for resizing text contained in an image comprising:
a browser for displaying a hypermedia document;
an extractor/separator for identifying images in said hypermedia document;
a filter for identifying text portions of said identified images;
an optical character recognition (OCR) system for processing said identified text portions, said OCR system producing recognized text; and,
a user interface for displaying said recognized text concurrently with said display of said hypermedia document in said browser.

12. The system of claim 11, further comprising:
a text-to-speech (TTS) conversion system for converting said recognized text to audible speech; and,
an audio user interface (AUI) for presenting said TTS audible speech concurrently with said display of said hypermedia document in said browser.

13. The system of claim 11, further comprising:
a transcoder for reformatting said hypermedia document to accommodate a resizable display, said transcoder embedding an image identifier associated with said image in said hypermedia document; and,
an event handler for providing a resizable display of said recognized text responsive to detecting an operating system event relating to said image.

14. The system of claim 11, further comprising:
a display template generator for creating a display template corresponding to said hypermedia document, said display template schematically illustrating both portions of said hypermedia document which contain images which are determined to contain text which can be resizably displayed in a user interface; and,
a user interface for displaying said display template concurrently with said display of said hypermedia document in said browser.

15. A machine readable storage having stored thereon, a computer program having a plurality of code sections for resizing text contained in an image, said code sections executable by a machine for causing the machine to perform the steps of:
recognizing text contained in an image included in a hypermedia document displayed in a hypermedia document browser; and,
providing a resizable display of said recognized text in a user interface concurrently with said display of said hypermedia document in said hypermedia document browser.

16. The machine readable storage of claim 15, wherein the text recognition step comprises:
identifying an image in said hypermedia document;
further identifying text contained in said identified image; and,
processing said identified text in an optical character recognition (OCR) system, said processing producing recognized text.

17. The machine readable storage of claim 16, further comprising:
identifying additional images in said hypermedia document, said additional images containing corresponding additional text;
further identifying said corresponding additional text contained in said additional images;
processing said further identified additional text in said OCR system, said processing producing additional recognized text; and,
providing a resizable display for selected ones of said additional recognized text concurrently with said display of said hypermedia document in said hypermedia document browser.

18. The machine readable storage of claim 15, further comprising:
text-to-speech (TTS) converting said recognized text; and,
presenting said TTS converted text in an audio user interface (AUI) concurrently with said display of said hypermedia document in said hypermedia document browser.

19. The machine readable storage of claim 16, wherein said identifying step comprises:
parsing said hypermedia document for embedded image references.

20. The machine readable storage of claim 15, wherein said providing step comprises:
transcoding said hypermedia document to accommodate a resizable display, said transcoding embedding an image identifier in said hypermedia document; and,
responsive to detecting user interaction with an image associated with said identifier, providing a resizable display of recognized text contained in said image.

21. The machine readable storage of claim 20, wherein said transcoding step comprises:
embedding a marker in said hypermedia document proximately to said image, said marker indicating the availability of a resizable display for resizably displaying text contained in said image.

22. The machine readable storage of claim 20, wherein said detected user interaction comprises pointing device events occurring positionally proximate to said text contained in said image.

23. The machine readable storage of claim 17, further comprising:
determining whether each identified image contains text which can be resizably displayed in a user interface;
creating a display template corresponding to said hypermedia document, said display template schematically illustrating portions of said hypermedia document which contain image portions which are determined to contain text which can be resizably displayed in a user interface; and,
displaying said display template.

24. The machine readable storage of claim 18, further comprising:
determining whether each identified image contains text which can be resizably displayed in a user interface and further determining whether each identified image contains text which can be audibly presented in an AUI;
creating a display template corresponding to said hypermedia document, said display template schematically illustrating both portions of said hypermedia document which contain image portions which are determined to contain text which can be resizably displayed in a user interface, and portions of said hypermedia document which contain image portions which are determined to contain text which can be audibly presented in an AUI; and,
displaying said display template.
